(19) United States
(12) Patent Application Publication
(10) Pub. No.: US 2004/0059590 A1
(43) Pub. Date: Mar. 25, 2004

(54) Credential promotion

(76) Inventors: Dwayne Mercredi, Sherwood Park Alberta (CA); Rod Frey, Alberta (CA); Gregory C. Jensen, Redmond, WA (US)

Correspondence Address: WOOD, HERRON & EVANS, LLP, 2700 CAREW TOWER, 441 VINE STREET, CINCINNATI, OH, 45202, US

(21) Appl. No.: 10/398,355

(22) PCT Filed: Sep. 13, 2002
(86) PCT No.: PCT/US02/29166

(51) Int. Cl. G06F 17/60

(52) U.S. Cl. 705/1

(57) ABSTRACT

An apparatus, method and program product allow a user (100) who is authenticated (84) in one application to enroll in a different application (95) without having to accomplish conventional enrollment processes. The enrollment credential of the first application (84) is automatically transferred to the second application (95) as the new or updated enrollment credential for the second application (95).

### FIELD OF THE INVENTION

The present invention relates generally to identity authentication technologies, and more particularly, to establishing and maintaining user enrollment for applications having secured electronic information.

### BACKGROUND OF THE INVENTION

Considerations regarding the safeguarding of computer resources and other electronic data have become indispensable throughout industry, government and private channels. Security measures require users to enroll into applications incident on a computer, a palm pilot, a cellular phone, or other device configured to provide access to secured electronic data. An enrollment session typically requires users desiring access to the electronic data to provide an identifier, such as a user ID, in addition to repeated submissions of an authentication credential. Software incident on an enrollment device receives, or “captures,” the submitted authentication credentials and processes them to create an enrollment credential. The enrollment credential may be stored and subsequently compared against submitted capture credentials to authenticate the identify of the user at a later time.

A Biometric Identification Record (BIR) is an example of a preferred authentication credential. A BIR generally comprises an electronically stored file correlated to a unique behavioral or physical characteristic of an individual. The individual may rely on the BIR as a form of identification or authentication. Common physical characteristics include fingerprints, voice recognition, hand geometry, and facial, retinal/iris characteristics. Exemplary behavioral characteristics generally include electronic signatures, keystroke pattern and gait. The highly correlative nature of BIR's generally makes them more difficult to falsify as compared to non-biometric credentials, such as passwords and tokens. BIR techniques can further relieve users from having to remember passwords or carrying tokens, while discouraging credential theft, borrowing and other suspect security deviations.

As with any authentication technique, establishment of a reliable enrollment credential is fundamental. Conventional BIR enrollment processes require users to repetitively resubmit capture BIR data after an initial submission in order to create an acceptable enrollment BIR. For instance, a typical fingerprint enrollment process may require a user to re-accomplish the same fingerprint submission over eight times. Enrollment software may subsequently process the multiple submissions into a combined, single enrollment BIR. That is, the software may combine the submissions, in some instances by programmatically “stitching” them into a larger-scale fingerprint that defines more mathematical and statistical matching points.

While such repetitious submission may be accomplished relatively easily in the context of passwords and tokens, BIR capture techniques pose more of a hardship and inconvenience to users and administrators establishing enrollment in an application. This burden is compounded exponentially where the same user must enroll in several such applications. That is, every application requires its own, respective enrollment process. Each of those processes, moreover, mandates the requisite, repetitive re-submission of BIR data particular to the application. As such, enrollment practices may represent a significant drain on time, efficiency, energy and other user and system resources. Negative perceptions associated with enrollment practices may often translate into a reluctance for users and administrators to avail themselves of available BIR practices and other protective security measures.

The same vexations and inefficiencies that plague users who are initially enrolling into an application may also apply to those user who are already enrolled in the application. For instance, currently enrolled users may be periodically required to re-accomplish enrollment processes to ensure accurate, up-to-date BIR's. Over time, changes to the physical features of users can render previously stored enrollment data less accurate or obsolete. Therefore, it is sound security practice to periodically re-enroll a user into every application for which there is current access to ensure that the stored enrollment BIR most accurately reflects any physical changes. Given the demanding requirements for enrollment, such updates may present an additional burden to users. Thus, users may be less prone to update their BIR data, which may become stale as a consequence.

While such difficulties associated with enrollment processes are often more prominent in the context of biometric technologies, the problems stemming from the repetitious and stringent nature of secure enrollment span across all authentication practices, to include password, PIN, smart card, key and other token applications. Therefore, there exists a universal need for a more efficient and otherwise improved manner for establishing and updating enrollment credentials.

### SUMMARY OF THE INVENTION

The present invention provides an improved apparatus, program product and method for automatically establishing and updating enrollment credentials across multiple computer applications in a manner that addresses the above described shortcomings of conventional enrollment practices. In accordance with the principles of the present invention, an authenticated user who is already enrolled into a first computer application may automatically transfer the enrollment credential of the first computer application to a second application. As such, the user may enroll in the second application without having to accomplish conventional enrollment processes. Rather than having to repetitiously resubmit authentication credentials, if that user has enrolled into the first application using authenticated data, their enrollment credential from the first application transfers to the second application. Thus, automatic enrollment of the user is achieved. The retrieved, or “promoted” enrollment credential from the first application becomes available for matching against a capture credential that is correlated to the user.

Consequently, matching processes include retrieval of the capture credential. A suitable capture credential may be submitted by the user at the client computer or other enrollment device. For instance, a user may provide a fingerprint signature to an electronic pad configured to receive the BIR. Another credential promotion sequence in accordance with the principles of the present invention may alternatively include the capture credential being retrieved from memory. Such may be the case where a user has only recently submitted a capture BIR for the first application. Where so configured, the recently stored capture BIR may be downloaded directly for comparison against the enrollment BIR. Thus, features of the present invention may obviate the need for the user to submit a capture credential in order to be enrolled. In any case, where a match is determined, the enrollment credential of the first application is stored as the enrollment credential for the second application.

Where desired, a user may simultaneously be enrolled in multiple, different applications in similar fashion. That is, processes configured to successively or simultaneously store a retrieved enrollment credential as the new enrollment credential for a plurality of applications may be automatically initiated. In this manner, a single authentication credential may be simultaneously promoted to several applications, thus enrolling the user instantly in a multitude of applications. Such a feature of the present invention may thus mitigate lengthy time demands associated with conventional enrollment practices.

Furthermore, the principles of the present invention apply equally to the updating of credentials throughout a network. One or more enrollment credentials correlated to a user may be automatically updated in response to the user updating an enrollment credential in another application. Thus, aspects of the present invention can enable further time savings and efficiencies.

Processes used to locate and determine the appropriateness of the enrollment credential and/or the first application associated therewith may be automatic, as well as stipulated by an application, system mandate, or user input, among other directives. Selection of the application/enrollment credential may further implicate evaluation of local, user, global and other policies. Optionally, the fact that a promotion process was accomplished for the user may be recorded for accountability and security purposes.

By virtue of the foregoing, there is thus provided an improved mechanism for establishing and updating authentication credentials in a manner that addresses above-identified shortcomings of known authentication systems. These and other objects and advantages of the present invention shall be made apparent from the accompanying drawings and the description thereof.

### BRIEF DESCRIPTION F THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a block diagram of a client-server computer system consistent with the present invention;

FIG. 2 is a network system suited to execute credential promotion processes consistent with the present invention;

FIG. 3 is a dialog box having application within the network environment of FIG. 2;

FIG. 4 is a flowchart outlining method steps suited for execution within the network environments of FIGS. 1 and 2;

FIG. 5 is a flowchart having steps configured to initiate programmatic method steps of FIG. 4;

FIG. 6 is a flowchart having method steps configured to determine an enrollment BIR as applied in the flowchart of FIG. 3;

FIG. 7 is a dialog box having application within the process steps of FIG. 6; and

FIG. 8 is a flowchart having method steps suited for updating authentication credentials within the network environments of FIGS. 1 and 2.

### DETAILED DESCRIPTION

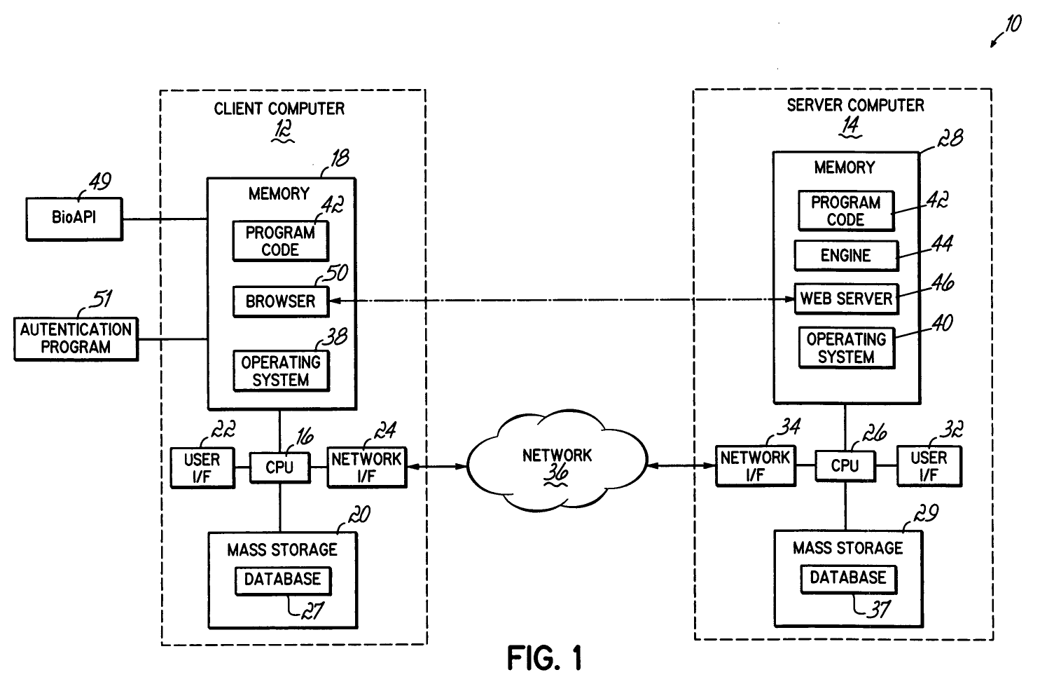

Turning now to the Drawings, wherein like numbers denote like parts throughout the several views, FIG. 1 illustrates a client-server based computer system 10 that is consistent with the principles of the present invention. With reference generally to FIG. 1, there is shown an embodiment of a client-server system 10 configured to establish enrollment credentials across different applications of a network. The system 10 may similarly affect updates throughout the network for all applications in which the user is already involved. To this end, the system 10 may automatically enroll into a second computer application a user who is already enrolled into a first application.

The system 10 may initially locate the first application within a designated trust network or other set of predefined user devices and applications. An authentication credential used to enroll the user in the first application may then be downloaded into memory of the second application. The second application may store the downloaded authentication credential as its new enrollment credential correlated to the user. Thus, the user may subsequently access the second application using the same authentication credential used in the first application. Alternatively or in addition, updates to the stored enrollment credential of the second application may be affected to reflect those changes made in the first application.

System 10 includes at least one apparatus, e.g., one or more client computers 12 and one or more server computers 14. For the purposes of the invention, each computer 12, 14 may represent practically any type of controller, computer system, cell phone, personal digital assistant (PDA) or other programmable electronic device capable of functioning as a client and/or server in a client-server environment. Moreover, each computer 12, 14 may be implemented using one or more networked computers or other controllers, e.g., in a cluster or other distributed computing system. Moreover, as is common in many client-server systems, typically multiple client computers 12 will be interfaced with a given server computer 14.

Computer 12 typically includes a central processing unit 16 including at least one microprocessor coupled to a memory 18, which may represent the random access memory (RAM) devices comprising the main storage of computer 12, as well as any supplemental levels of memory, e.g., cache memories, non-volatile or backup memories (e.g., programmable or flash memories), read-only memories, etc. In addition, memory 18 may be considered to include memory storage physically located elsewhere in computer 12, e.g., any cache memory in a processor in CPU 16, as well as any storage capacity used as a virtual memory, e.g., as stored on a mass storage device 20 or on another computer coupled to computer 12.

Computer 12 also typically receives a number of inputs and outputs for communicating information externally. For interface with a user or operator, computer 12 typically includes a user interface 22 incorporating one or more user input devices (e.g., a keyboard, a mouse, a trackball, a joystick, a touch pad, smart card slot, retinal/fingerprint scanner, smart card/key, token detector and/or a microphone, among others) and a display (e.g., a CRT monitor, an LCD display panel, and/or a speaker, among others). Otherwise, user input may be received via another computer or terminal.

For additional storage, computer 12 may also include one or more mass storage devices 20, e.g., a floppy or other removable disk drive, a hard disk drive, a direct access storage device (DASD), an optical drive (e.g., a CD drive, a DVD drive, etc.), and/or a tape drive, among others. Furthermore, computer 12 may include an interface 24 with one or more networks (e.g., a LAN, a WAN, a wireless network, and/or the Internet, among others) to permit the communication of information with other computers and electronic devices. It should be appreciated that computer 12 typically includes suitable analog and/or digital interfaces between CPU 16 and each of components 18, 20, 22 and 24 as is well known in the art.

In a similar manner to computer 12, computer 14 includes a CPU 26, memory 28, mass storage 30, user interface 32 and network interface 34. However, given the nature of computers 12 and 14 as client and server, in many instances computer 14 will be implemented using a multi-user computer such as a server computer, a midrange computer, a mainframe, etc., while computer 12 will be implemented using a desktop or other single-user computer. As a result, the specifications of the CPU's, memories, mass storage, user interfaces and network interfaces will typically vary as between computers 12 and 14. One skilled in the art should additionally appreciate that other hardware environments are contemplated within the context of the invention.

Computers 12, 14 are generally interfaced with one another via a network 36, which may be public and/or private, wired and/or wireless, local and/or wide-area, etc. Moreover, network 36 may represent multiple, interconnected networks. In the illustrated embodiment, for example, network 36 may include the Internet.

Each computer 12, 14 operates under the control of an operating system 38, 40, and executes or otherwise relies upon various computer software applications, components, programs, objects, modules, data structures, etc. [e.g., promotion program 42, biometric authentication program 51 and BioAPI 49, among others. BioAPI 49 regards an exemplary programming interface supplied by biometric service providers that provides enrollment and verification services for installed biometric devices]. Moreover, various applications, components, programs, objects, modules, etc. may also execute on one or more processors in another computer coupled to computer 12, 14 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer and/or network of computers, and that, when read and executed by one or more processors in a computer or other device, cause that computer/device to perform the steps necessary to execute steps or elements embodying the various aspects of the invention.

While the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Furthermore, embodiments consistent with the invention may be configured to promote credentials using applets and other such layers of software via an active hypertext document. As is well known in the art, applets may be used to generate active hypertext documents through which clients may supply input data for transmission to a server 14. As discussed herein, credential promotion operations may be implemented by embedding one or more instructions within the active hypertext document to initiate the performance of the promotion by the client computer 12.

One or more applets may be configured for execution by an engine 44 resident on the server computer 14. The engine 44 may process the applets to generate one or more active hypertext documents for transmission to a client by a web server 46 that is also resident on the server 14. Such active hypertext documents are downloaded to client devices/computers, e.g., as illustrated at block 48 in FIG. 1. In one embodiment, such active hypertext documents may be processed by a client-side web browser 50, which renders the documents on a client display. The web browser further generates requests to the server 14 that supply input data to the server 14 in response to user input in a manner well known in the art.

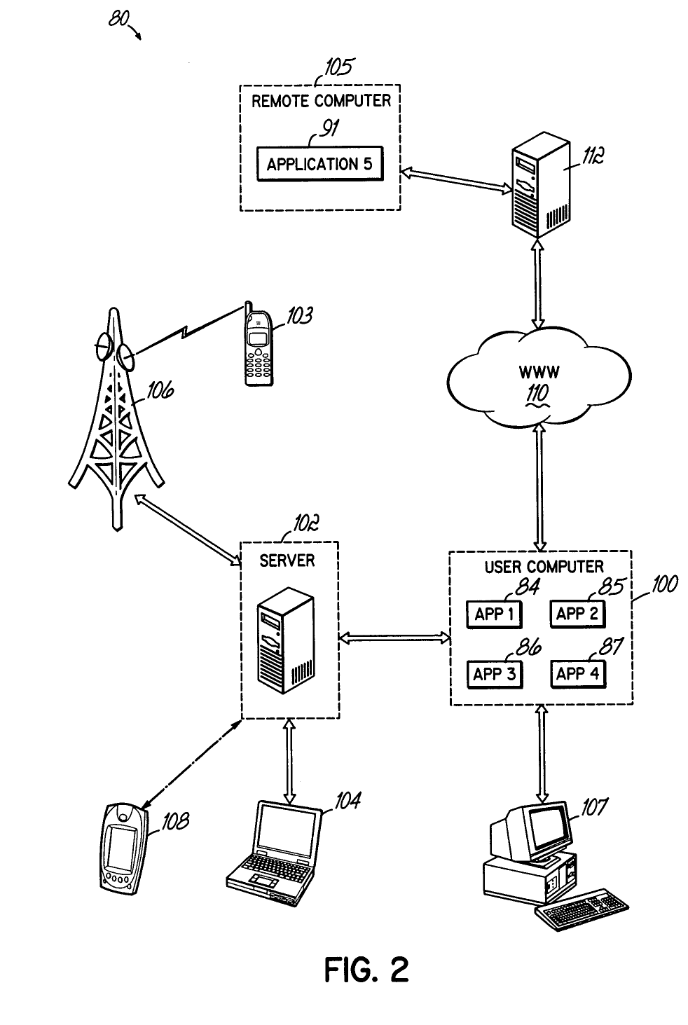

Those skilled in the art will recognize that the exemplary environment illustrated in FIG. 1 is not intended to limit the present invention. Indeed, those skilled in the art will recognize that other alternative hardware and/or software environments may be used without departing from the scope of the invention. One such exemplary environment is illustrated in FIG. 2.

The network system 80 of FIG. 2 may be configured to automatically enroll a user who is already enrolled into a first application into a second application. The system 80 may support any number and manner of users attempting to enroll into multiple computer applications 84-91. The applications 84-91 may be either dispersed or concentrated throughout the network 80, as may be the respective user enrollment devices 100-108. For purposes of an embodiment of the invention, a suitable application may comprise an operating system, domain, network, component, program, object, module, program, library, memory, sequence of instructions or virtually any function having underlying programmatic code that may relate to enrollment practices.

Typically, each user is already enrolled in one or more of the applications 84-91. Thus, each user may have accomplished requisite credential authentication processes associated with at least one application 84-91. Such authentication processes may include repeated submission of one or more credentials, including a password, a BIR, or an authentication token. Thus, it should be appreciated that the principles of the present invention apply equally to all authentication practices and credentials. Consequently, “credential,” “authentication credential,” “token,” “BIR,” “password,” and other authentication naming conventions are used interchangeably throughout this specification.

Each user may have accomplished the prior enrollment at a myriad of enrollment devices, to include computer terminals 100-102, 105 and 107. Other users may enroll using a cell phone 103, a palm pilot 108 or another handheld device. Suitable user enrollment devices 100-108 for purposes of an embodiment of this invention need merely comprise a controller configured to receive and process instructions relating to authentication data. One skilled in the art should appreciate that in certain embodiments, the controllers/user devices 100-108 need not even connect to a network, nor have an authenticating capture device located therewith. That is, those embodiments of the present invention that permit a user to promote an authentication credential without first requiring submission of a capture authentication credential may enable the user or administrator to initiate the promotion processes remotely, irrespective of capture device availability or compatibility with regard to the user device 100-108. As discussed below, such a scenario may involve the retrieval of a stored capture credential correlated to the user from memory or a transmission.

In any case, a user at a client terminal 100 may be enrolled in a first application 84 residing within an operating system of the computer 100. A user may have enrolled at the client computer/user device 100 in the first application 84 using a BIR or other authenticating credential. It is largely inconsequential with regard to the promotion processes of the present invention whether or not the first application 84 resides at the client computer 100, as credential promotion may occur as between networked devices. The same user may subsequently require or desire access to a second application 85. Conventionally, the user would be required by the second application 85 to repetitively re-enroll the BIR or other authentication credential. In an embodiment of the present invention, however, the program code 42 resident within the client computer 100 may alternatively initiate credential promotion processes.

Typical credential promotion processes may involve retrieving an enrollment credential from the first application 84. The retrieved enrollment credential is usually correlated to the user's enrollment in the first application 84. The program code 42 may then retrieve a capture authentication credential correlated to the user. For instance, the program code 42 may prompt the user to submit a capture BIR. The program code 42 may then determine if the capture BIR received from the user matches the retrieved enrollment BIR within predetermined parameters. One should appreciate that a suitable capture credential may additionally comprise a BIR or other credential retrieved from cached memory or sampled from an electronic transmission.

Should a match between the retrieved capture BIR and the retrieved enrollment BIR be established, the retrieved enrollment BIR may be correlated to the user's enrollment in the second application 85. As such, the user may be automatically enrolled in the second application 85 without having to go through the typical biometric enrollment process. Similarly, the user of another or the same embodiment of the present invention may simultaneously be enrolled in multiple different applications. That is, the program code 42 may successively or simultaneously initiate processes configured to store the retrieved enrollment BIR as the new enrollment BIR for a plurality of applications.

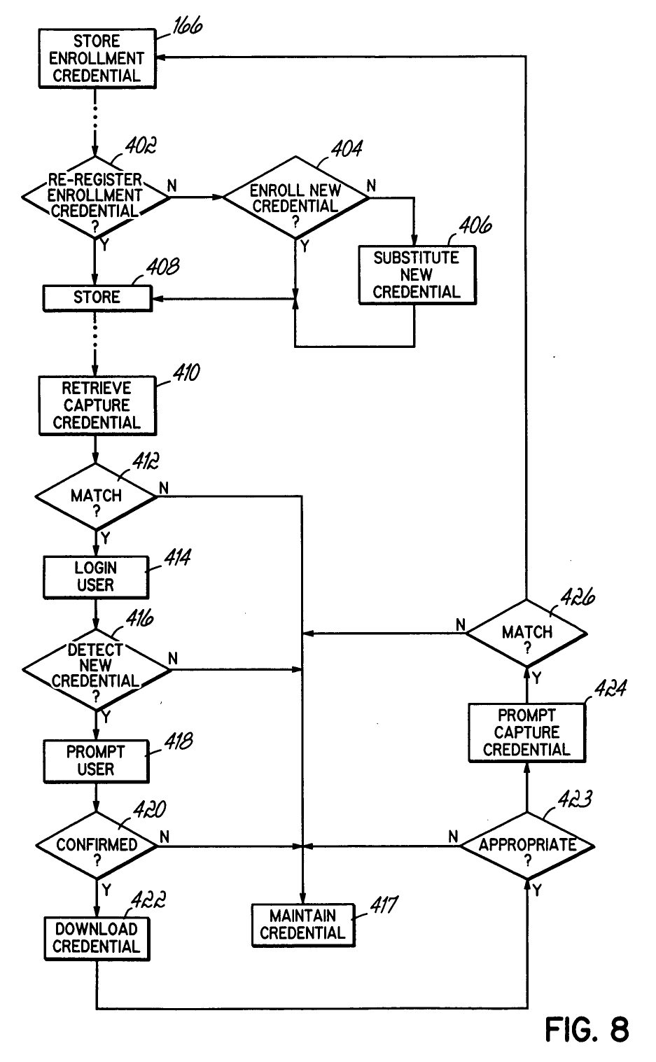

One of skill in the art should further appreciate that the principles of the present invention may apply equally to credential updates throughout a network. As described in greater detail in the text describing FIG. 8, the program code 42 may simultaneously update one or more enrollment credentials correlated to a user in response to the user updating an enrollment credential in another application. Thus, update features of the present invention can enable further time savings and efficiencies.

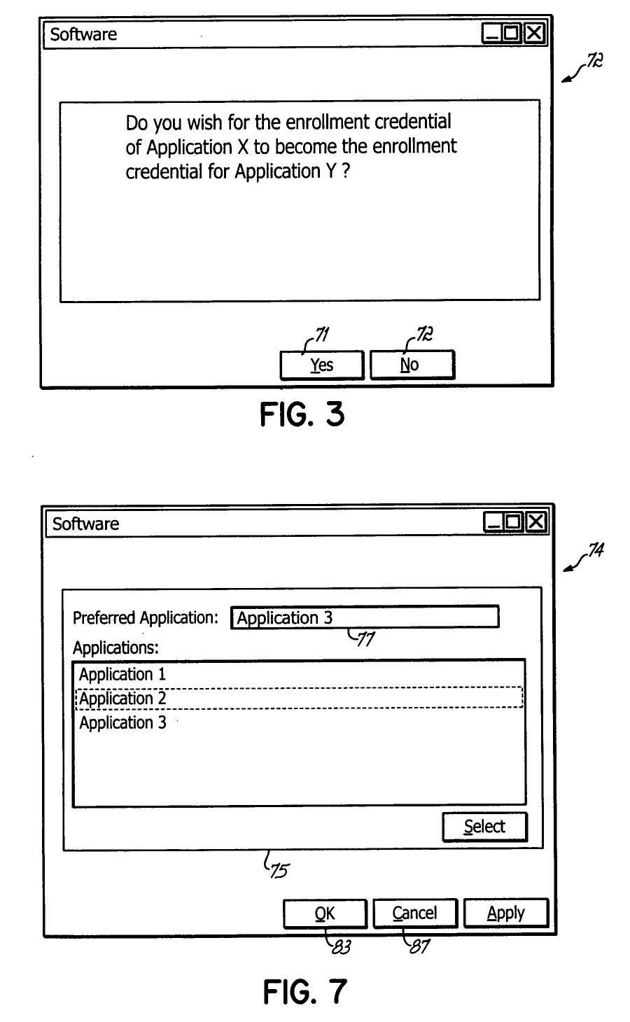

A successful match between the capture and enrollment authentication credentials may further result in the user having immediate access to the second application(s) 85. That is, the user may be automatically logged into the second application 85 by the program code 42. Alternatively, the program code 42 may prompt the user to first verify that they wish for the Credential promotion processes to occur. For instance, the browser window 70 as shown in FIG. 3 may solicit direction from the client. Affirmative input from the user at field 71 of FIG. 3 may initiate subsequent storage of the first enrollment credential as discussed above.

A negative response from the user at field 72 of FIG. 3 may have the same affect as if no match was established as between the capture and enrollment credentials. In one embodiment, this affect may mean the program code 42 at the client computer 100 relegates the user to accomplishing conventional enrollment processes as per the normal operating procedures of the second application 85. For example, the user must repeat multiple BIR captures to establish an enrollment BIR. Similarly, should credential promotion be unavailable as per a system, application or local policy, among other criteria discussed below, then alternative enrollment processes may commence.

Credential promotion processes may include a determination of one or more programmatically defined trust networks. For purposes of this disclosure, a trust network may include one or more applications that run on a single, or multiple client devices. Embodiments of the present invention typically, but do not necessarily, include predetermined designations of trust networks. Where desirable, some designations of trust networks may be stored in a database or on local hardware/computer registers. Alternatively, the program code 42 may dynamically determine a trust according to network connectivity, as well overarching user and/or administrative input.

As such, a trust network may comprise hardware supporting a selected field of applications from which an enrollment credential may be located. System 80 policy may dictate and define trust membership. For instance, an administrator may include within a predefined trust network consistent with the principles of the invention only clusters of terminals known to be of a requisite security level. In this manner, the network system 80 of FIG. 2 may comprise one or more such trust networks. In another embodiment, the system 80 may account for only a part of a more comprehensive trust network.

Where a trust network cannot be established for a user, alternative enrollment processes may be initiated as the program code 42 aborts credential promotion processes. Where a trust network is alternatively determined, the program code 42 may initiate location of a suitable enrollment credential from within the applications of the determined trust network. That is, the program code 42 may search the trust network for an enrollment credential of a first application 84 into which the user is already enrolled. The program code 42 may determine where to look for the enrollment credential from any or a combination of factors discussed directly.

Factors affecting from where an enrollment credential is retrieved may include a designation or programmatic preference for a particular application and/or enrollment credential. Such a designation may be made in certain instances by an administrator, the user, or the second application into which the user desires enrollment. For example, the administrator may store an address of an application 84 having a preferred enrollment BIR within a designated memory field that is accessible to the program code 42. The enrollment BIR of the designated application 84 may be desirable due to circumstances surrounding its clarity, size, accessibility and/or security, among other considerations.

In another example, the second application 85 may instruct a web browser 50 to sample a designated register that is common to all devices 100-108 expected to access the second application 85. The program code 42 may then process this information to make a determination of a preferred application/enrollment BIR. The program code 42 of another or the same embodiment may use the BIR enrollment data from the application 84 from which the user is attempting to access the second application 85. As such, the program code 42 may retrieve the application 84 address from registers of the computer 100 to determine an appropriate enrollment credential. In another embodiment, the user may designate their own preferred address for an application 86. As such, the user may enter an application name or other identification in a manner that may be processed by the program code 42.

Where desired, the program code 42 may then evaluate the appropriateness of the designated application and associated credentials. For instance, one embodiment may programmatically determine which, if any, designated enrollment authentication credentials is best suited for promotion to the second application(s) 85. The determination may include considerations relating to local, user and overarching system mandates, as well as assigned confidence ratings. Other considerations can include hardware availability at the local machine 100 of the user, as well as user preference and prior usage of the authenticating equipment. Thus, embodiments consistent with the principles of the present invention may rely on hierarchical layers of evaluation to determine a suitable enrollment BIR.

More particularly, the evaluation processes of one embodiment may prompt the program code 42 to access memory to see if a preference for one of the available applications/enrollment BIR's has been designated. For example, a database field associated with an account of the user and/or network system 80 may indicate a mathematical preference for an application linked to the field. Preferences may permeate other layers of evaluation, as well. For example, where more than enrollment BIR is available for a located application, another preference may weight selection towards a preferred enrollment credential, such as a BIR produced by a retinal scanner. In the absence of other input, the preference may act as a default choice of the program code 42. As discussed below, such a preference may be set prior to, during, or subsequent to an enrollment session.

A suitable preference in one embodiment may include a confidence rating. An exemplary confidence rating may be assigned by an administrator in view of reliability and security considerations. Confidence ratings may be assigned to either or both an application and a specific type of authentication credential. In operation, an administrator may assign a higher confidence rating to an application having known, high-end security standards than to a second application exhibiting less stringent practices. The program code 42 may select the application having the higher confidence rating when determining where from to retrieve a suitable enrollment credential. Similarly, where more than one enrollment credential is available from the first application 84 for credential promotion purposes, the program code 42 may select a credential having the highest confidence rating. For example, the program code 42 may select a fingerprint BIR over a smart card enrollment credential.

Selection of an appropriate application may be accomplished in part in view of a local policy. More particularly, the program code 42 may initially access a local enrollment policy for the machine 100 at which the user desires to enroll. A local policy may include a preprogrammed preference or mandate for an application, a authentication credential, and/or a capture device. The local policy may be established by an administrator or a prior user for that machine 100. Such a local policy may further be stored on the local hard drive, or be accessible via the network 80.

Alternatively or in addition, a user policy associated with the account of the user may be evaluated to designate an application 84. For instance, a user BIR policy may be preset in a database field associated with a relevant account of the user. The field or other indicator may mandate one or more applications and/or enrollment credential types that are suitable for enrollment with regard to the user. Such a setting can act as a default or statistical preference for a particular user, directing the computer to select a single or ordered group of applications and/or enrollment BIR's from the trust network.

Another policy that may be accessed by the program code 42 to determine an appropriate application 84 from which to retrieve an enrollment credential may pertain to a global, or system policy. An exemplary system policy may apply to a network, a subsystem/cluster, or a group of user accounts. By virtue of this feature, an account manager or other administrator can designate groupings of machines or users having the particular security requirements mandated by the system policy. Tags relating to these requirements or settings may be programmatically attached to a database field associated with the designated machines/users. The program code 42 may then access these database fields to obtain applicable security settings and preferences. In one instance, the database fields/tags may link to a listing of an acceptable application(s) for credential promotion processes.

In some embodiments consistent with the invention, another consideration that may affect determination of an appropriate application regards device availability. The program code 42 may make an accounting of which biometric or other authentication devices are currently installed on the computer 100 from which the user seeks to enroll into the second application 85. For instance, the local computer 100 of the user may be equipped with both fingerprint and retinal biometric testing devices. Proprietary programs associated with conventional biometric testing devices (including BioAPI code 49) place a marker within a registry of the computer 100 upon installation and de-installation. This registry provides a mechanism for the embodiment to assess available devices. Another or the same embodiment may rely on processes that enumerate available devices in real time, or at the time of transcription, thus providing the program code 42 with an accounting of appropriate devices.

In an instance where the computer 100 is in communication with the network, the program code 42 may alternatively check a server 112 to obtain status information pertinent to available biometric devices. Should no acceptable biometric testing device corresponding to the enrollment credential type of the first application 84 be located on the computer 100, an embodiment of the software may look to another application. Another embodiment may, as above, relegate the user to enrollment using conventional enrollment processes, if the option is available.

The policies and criteria discussed herein in the context of driving an application selection process are included only for exemplary purposes. Accordingly, policies may be omitted, altered and supplanted with others in accordance with the principles of the present invention. While some such policies may be discriminating, others may simply sequence through an entire list of retrieved applications and/or credentials before finding one that is compatible with subsequently implemented policies. The program code 42 of still another embodiment may afford the user a choice of applications and/or enrollment credentials based upon availability and compatibility with the second application 85 and the equipment of the local machine 100. In any case, any number of alternative programs configured to suit the specific needs of the network system 80 may be used to determine an appropriate application 84 from which to retrieve an enrollment credential.

Should the authentication credential or set of credentials of the appropriate application 84 identified by the program code 42 conform to global, local, user, hardware and application policies, then the program code 42 may retrieve the enrollment credentials from a database or other memory accessible to the first application 84. The enrollment credentials, as discussed above, may be compared against a retrieved capture credential. To this end, the program code 42 may prompt the user to submit capture authentication credentials. For instance, the user may be presented with a biometric interface configured to guide them through a process of submitting a capture BIR. To this end, appropriate software may launch a designated/preferred biometric test according to the preset parameters of a biometric verification sequence. An exemplary sequence may include a displayed user interface screen configured to cause the user to provide a capture credential. For example, a fingerprint authentication application may prompt the user, “Please place your finger on the scanner.”

The capture credential may alternatively be retrieved from memory in accordance with the principles of the present invention. Such may be the case where a user has only recently submitted a capture BIR for the same or a different application. Where so configured, the program code 42 may download the recently stored capture BIR for comparison against the enrollment BIR. Thus, one embodiment of the invention does not require the user to submit a capture BIR to realize credential promotion.

Should a match be established at the local client computer 100, the retrieved authentication credential may be stored as the current enrollment credential for the second application 85. Thus, the same authentication credential comprises the enrollment credential for both the first and second applications 84, 85. The program code 42 may first verify with the user their intent to have the enrollment credential from the first application 84 promoted to the enrollment credential for the second application 85 prior to storing it as such. Where desired, the fact that a credential promotion was accomplished my be recorded at a network and/or local level for security and accountability purposes.

As shown in FIG. 2, credential promotion processes may span entire networks and are not typically limited to those applications incident on a single machine 100. Using browser and related technologies, the same user accessing an application 85 that executes at client terminal 100 may additionally enroll in another application 91 present at another client terminal 105. As such, embodiments consistent with the invention accommodate and complement known Internet 110 and server 112 processes. The mechanics of such browser and web server interaction is better illustrated in the client-server block diagram of FIG. 1.

The browser 50, or other interface program of FIG. 1 may send a hypertext transfer protocol (HTTP) request to the server 14. The HTTP request may embody a “get” command and/or an instruction to access the second application 91. Processing of the HTTP request at the server 14 may result in the invocation of an applet on the server 14. The applet may generate an active hypertext document and transmit the resultant HTML page/document to the browser 50 via an HTTP response of its own. The document may then be displayed by the web browser 50 at the client computer 12.

In one embodiment, the HTTP response from the server 46 may include an applet program configured to prompt a BIR. For instance, the HTTP response may include enrollment processes particular to the application 91 into which enrollment is sought. The program code 42 executing on the browser 50 may initiate the BIR enrollment process applet conveyed in the HTTP response, and initiate its own Credential promotion processes, accordingly. As discussed herein, Credential promotion code may determine and retrieve BIR enrollment data from a designated or otherwise determined application 84. In executing the respective program code 42, the browser 50 may match the enrollment BIR of the first application 84 with a capture BIR submitted by, stored in relation to, or otherwise correlated to the user.

In determining a match, the browser 50 may send another HTTP command to the server 14. The command response may include an indicator that communicates to the server 14 that the user should be authenticated. In another embodiment, the browser 50 may transmit to the server 14 bitstream or other data indicative of the actual enrollment BIR retrieved from the first application 84. In either case, the program code 42 incident at the remote computer 14 and/or additional application 91 may store the retrieved enrollment BIR as its own. Where enrollment data cannot be stored as such, the server 14 may generate an error message that is transmitted back to the browser 50.

One skilled in the art should appreciate that the invention is not limited to particular server or client-side program code implementations. As such, these and other exemplary embodiments in accordance with the principles of the present invention are described herein for exemplary purposes. Moreover, although networked computers are shown in FIGS. 1 and 2 for the purpose of illustrating the functionality of an exemplary application of the invention, other embodiments consistent with the principals of the present invention may suitably include machines isolated from any network connection.

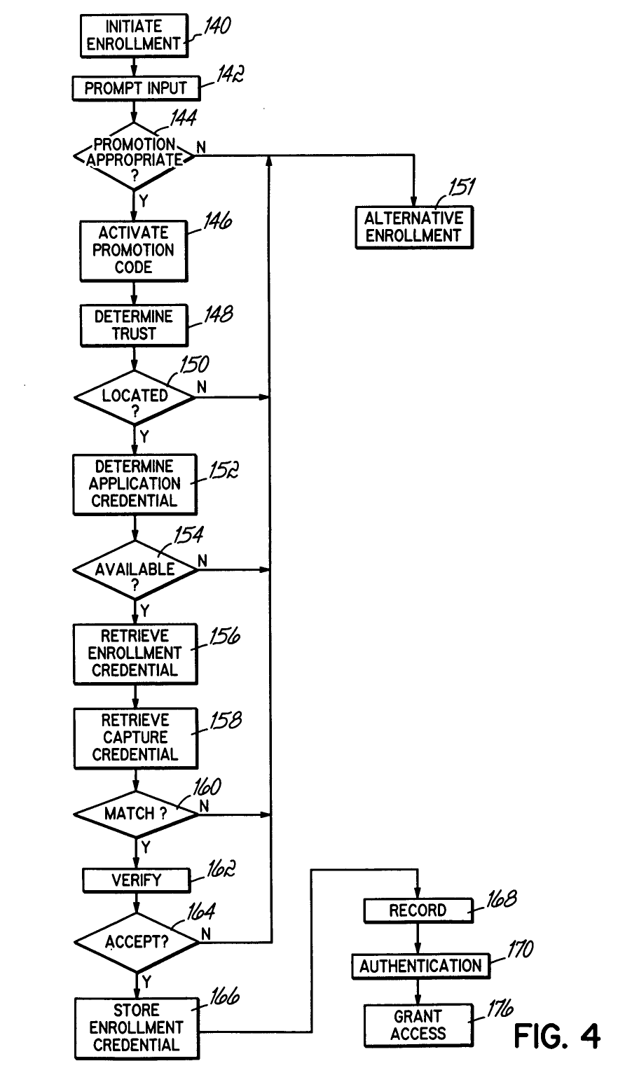

The flowchart of FIG. 4 shows exemplary method steps suited for execution with the hardware environments of FIGS. 1 and 2. That is, the illustrative steps of FIG. 4 may enable a user enrolled in a first application 84 to enroll in a second application 85 using enrollment authentication credentials of the first application 84. Turning more particularly to the flowchart of FIG. 4, a user may initiate enrollment processes for the second application 85 at block 140. That is, the user may access a keypad, mouse, microphone, electronic notepad/palm pilot or some other input device to select an interface option of a display. The second application 85 may conventionally prompt the user to provide data and credentials necessary for enrollment at block 142.

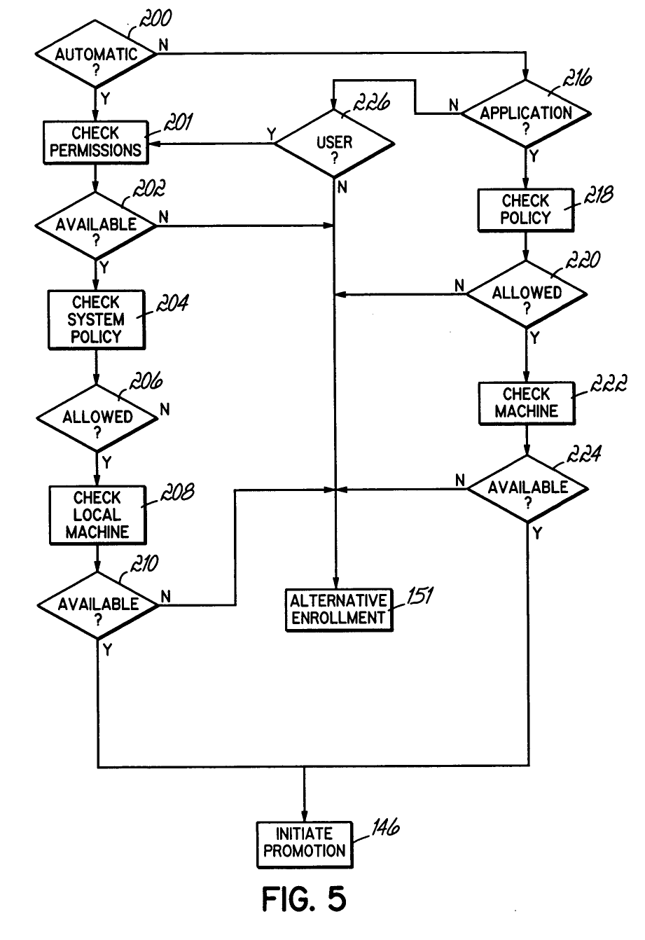

As discussed in greater detail in the text describing FIG. 5, the availability and appropriateness of credential promotion processes as determined at block 144 may be determined according to a network administrator, policy or user preference, among other considerations. Where determined to be appropriate, additional processes associated with credential promotion are initiated at block 146.

Credential promotion processes initialized at block 146 of one embodiment may generally include or precede a determination of a trust network at block 148. Trust networks may be defined according to physical connectivity, system policy, user preferences, and/or application requirements, among other requirements. Trust networks typically include a grouping of networked devices having at least limited two-way connectivity. Trust networks may alternatively and/or additionally include independent, non-networked devices, such as found in a distributed Public Key Infrastructure, where multiple stand-alone machines share a common access code or process. In any case, trust network listings may be statically stored or dynamically generated depending upon system 80 capability and policy. For instance, the program code 42 may search a database having a field correlated to the user desiring access to the second application 85. The program code 42 may correlate that field to stored listings of networks and/or devices retrieved from the database and maintained in a linked relationship.

Some such trust listings may be stored in associative relationship with a confidence rating assigned by a network administrator. An exemplary confidence rating may reflect perceived security in the respective trust network. For instance, a network administrator may assign a low confidence rating to a trust network having components located outside of their internal organization, as opposed to a network consisting only of users in that organization. Other trust networks may be determined from an evaluation of hardware registers and stored addresses retrieved from a user hard drive 146.

Where the program code 42 fails to locate a trust network associated with the user, application and/or local machine 100 at block 150, the user may be relegated to alternative enrollment processes at block 151. These alternative enrollment processes may include the repetitive credential submissions associated with conventional enrollment processes. Alternatively, where a trust network is established at block 150, program code 42 consistent with the principles of the invention may determine from where to retrieve a suitable enrollment BIR. In one embodiment, exemplary program code 42 may determine the location of an application 84 in which the user has already completed enrollment processes.

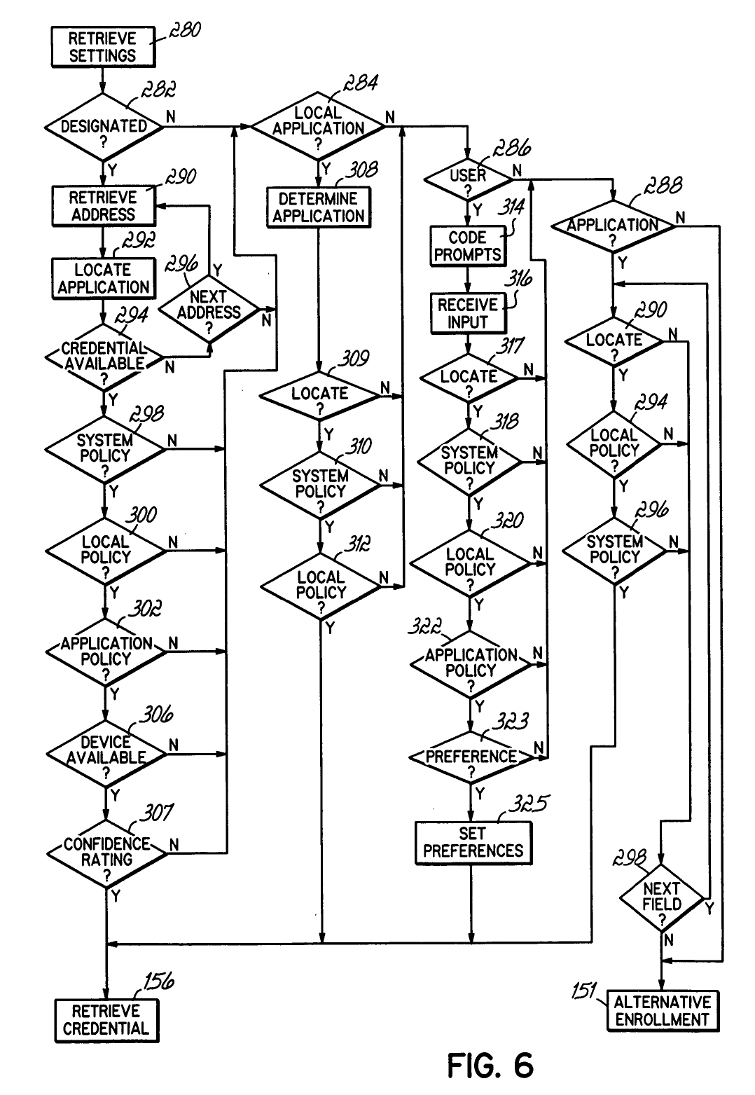

Though discussed in greater detail in the text describing FIG. 6, such location processes may involve the program code 42 accessing a designated application address stored in a local or network level register. Another embodiment may retrieve enrollment information from the local application 84 from which the user originally launched their request to enroll in the second application 85. The program code 42 of still another embodiment may permit the user to enter an address or other identifier correlated to an application 84 from which they personally desire their enrollment information to be retrieved. The new application 85, itself, may indicate a generic field or register from which to retrieve application address information in another embodiment. One skilled in the art should appreciate that other processes may be substituted for those listed above in connection with determining wherefrom to retrieve an enrollment credential. As such, processes and policies suited to locate designated applications may be configured to accommodate different network requirements and preferences.

The program code 42 at block 154 may then determine if the application designated at block 152 is available and/or desirable. Such processes may include verifying that requisite permissions are in place for the user with regard to both the first and possibly the second applications. At block 154, the program code 42 may then retrieve a single or a set of enrollment credentials used and stored in connection with the first application 84. To this end, the program code 42 may be configured to query the first application 84 as to the stored location of its enrollment credentials.

As discussed herein, the program code 42 may further access instructions allowing it to discriminate as between a multitude of enrollment credentials that may be stored in connection with the first application 84. For instance, the program code 42 may select only the enrollment credential associated with a highest confidence rating. By way of example, an administrator may assign a higher confidence rating to a biometric authenticating credential than to a less correlative, conventional password credential. The program code 42 of another embodiment may select only one or two of the available authenticating credentials matching those types compatible with the second application 85. Still another embodiment may retrieve all authenticating credentials in anticipation of distinguishing between or sequencing through all available credentials at a later time.

At block 158, the program code 42 may retrieve capture credentials correlated to the user. While one embodiment may allow the capture credential to be retrieved from memory, another may prompt immediate capture of the user's authenticating credential. More particularly, program code 42 may retrieve software associated with the designated biometric in preparation of the biometric challenge at block 158. The software may then launch an appropriate biometric test according to the preset parameters of the biometric verification sequence. For example, the software may initiate and display a user interface screen configured to cause the user to provide the capture credential. The capture credential may be of the type corresponding to an enrollment credential retrieved at block 156. For instance, a voice authentication application may prompt the user, “Please speak into the microphone.” Where more than one enrollment credential is stored for a user, all or portion of those credentials may be simultaneously promoted, as per application specifications. Alternatively, the program code 42 may determine a most appropriate enrollment credential from among those stored, as discussed herein.

Thus, the program code 42 may receive the capture data at block 158. As is known in the art, some devices suited to receive such data can include a fingerprint or retinal scanner, DNA sampler, camera, radiation detector, microphone, as well as any other known biometric capture device. Moreover, while the embodiment discussed in conjunction with FIG. 4 basically concerns biometric enrollments, another embodiment may utilize a non-biometric authenticating credential, such as a token or a password. In any case, comparison processes may commence at block 160. Correlation standards and parameters used to determine a match may be elevated or diminished at block 160 according to confidence ratings assigned to an application and/or a type of implicated authentication credential. As such, considerations regarding where the enrollment BIR was retrieved from and the type of enrollment credential, among others, may affect correlation standards.

As a precaution, certain embodiments of the present invention may include checks designed to ensure that the user wishes for credential promotion to occur. For instance, the program code 42 may initiate the display of the exemplary browser window of FIG. 3 at block 162. In some instances, the program code 42 may cause the user to confirm their intent using an authentication credential process. For instance, a user may be prompted to submit a capture fingerprint signature in response to selecting field 71 of FIG. 3. The submitted fingerprint BIR could then be matched against the enrollment BIR of the second application at block 164.

Where credential promotion is approved at block 164, the enrollment credential retrieved from the first application 84 may now be stored as the enrollment credential for the second, desired application 85. The second application 85 may store the downloaded enrollment credential in a database or other accessible memory in anticipation of the user subsequently enrolling.

Optionally, an embodiment of the present invention may record at block 168 the fact that a promotion process was accomplished for the user for accountability and security purposes. Additionally, the user may be required to submit another capture authenticating credential at block 170 prior to gaining access to the application at block 176. Similarly, it should be recognized by one skilled in the art that any of the method steps of FIG. 4 may be interchanged, augmented, omitted, rearranged and modified to accommodate other system and application requirements and preferences.

The flowchart of FIG. 5 shows preprogramming options associated with initializing credential promotion processes at block 144 of FIG. 4. Initialization options/headings shown at blocks 200, 216 and 226 of FIG. 5 exemplify certain presets that may be available to a network administrator configuring the program code 42 within the system 10. In one respect, the options 200, 216 and 226 may represent initial screening processes to determine the applicability of credential promotion. Initialization of the processes in one embodiment may be automatic and/or keyed to an application or user.

At block 200, an embodiment may enable automatic initialization of such promotion processes. For example, the system administrator or local user may configure a local computer 100 to launch portions of the program code 42 in response to a user attempting to enroll into a new application. More particularly, a user's selection of an icon corresponding to a new application may automatically initiate credential promotion processes.

Where desired, the program code 42 may be configured to determine whether promotion processes are permitted for a designated application from a policy standpoint at block 202. To determine availability, the program code 42 may check a register or other memory associated with the new application. While credential promotion processes are, in principle, compatible with all known authentication applications, a network administrator or code designer may nonetheless designate certain applications as being inappropriate for promotion on account of policy and/or security reasons. In one embodiment, such designations can be stored within program code 42 incident at either or both the local machine 100 and the device having the new application. Should credential promotion processes be designated as inappropriate for the application at block 202, then an embodiment may relegate the user to alternative enrollment processes at block 151.

Even where credential promotion processes are available for an application at block 202, system policy at block 204 may nonetheless preclude initiation of the program code 42. Such a system policy may be established for an entire network. Other system policies may apply to groupings or clusters of machines and/or particular users. While the motivations behind system policies may vary as between different networks, their rationale typically includes security and processing considerations. A determination at block 206 that system policy precludes credential promotion processes may initiate alternative enrollment processes at block 151.

Determined conformance with a system policy at block 206 in some embodiments may precede a hardware appraisal at the local machine 100 at block 208. For instance, the program code 42 may determine whether an appropriate biometric login device is available at the local machine 100 of the client. In one scenario, promotion processes may require a device configured to capture data corresponding to the retinal scan enrollment credential of the second application 85. The program code 42 at block 210 may subsequently determine whether a retinal scanner or acceptable alternative is available at the local machine. The program code 42 may merely establish at block 210 if any (type-nonspecific) biometric enrollment device is present at the local machine 100, while the program code 42 of another embodiment may alternatively look for a specific type of authentication equipment, such as a slot card reading device. Where the program code 42 determines that no suitable authentication device is available for enrollment at block 210, then the user must enroll using alternative processes at block 151. Conversely, should a suitable device be available at block 210, then a next phase of Credential promotion code may be initiated at block 146.

The second application 85 of another embodiment may launch program code 42 determined to initially assess the appropriateness of credential promotion at block 216 of FIG. 5. Such processes may be initiated in response to an application 85 prompting software incident at the local machine 100 of the user. Such may be the case where the application 85 into which the user wishes to enroll responds to an initial HTTP or other request from the client with an instruction configured to initiate promotion program code 42. Such an instruction from the second application 85 may first cause the program code 42 to verify that credential promotion processes conform with system policy at block 218.

Where no system or administrative policy precludes credential promotion at block 220, the program code 42 may determine if a suitable enrollment authentication device is available on the local machine at block 222. Such a determination may be accomplished via registers present on the local machine 100 that record the installment of authenticating devices. Alternatively or in addition, the program code 42 may further initiate an evaluation of an individual user policy. Such a user policy may reflect an individual user's directive not to activate credential promotion. Moreover, one of skill in the art should appreciate that any number of additional checks and policies may be implemented into the exemplary sequence of the steps shown in FIG. 5. To this end, processes included in the flowchart may be removed, substituted or rearranged with respect to other steps in accordance with the principles of the present invention.

Where the program code 42 determines that credential promotion conforms with policy and hardware conditions determined at blocks 220 and 224, a next phase of credential promotion may commence at block 146. For instance, the credential promotion processes associated with determining a trust network may be initiated at block 148 of FIG. 4. As above, failure to satisfactorily conform with the policy and hardware requirements of blocks 220 and 224 of FIG. 5 may result in the user enrolling through alternative mechanisms at block 151.

The program code 42 may alternatively or additionally determine the initial appropriateness of promotion processes in response to direct user input at block 226. For instance, the user may click on a button, or check a dialog box labeled “BIR Promotion.” The button or other command mechanism may link to programmed instructions configured to guide the user through a promotion session. As with the automatically initiated sequence of block 200, the user initiated sequence beginning at block 226 may include policy and hardware checks similar or identical to those discussed in conjunction with blocks 201-206.

Whether automatically, application or user-activated at blocks 200, 216 or 226, respectively, the program code 42 may recognize at block 146 of FIG. 4 that credential promotion has been enabled. Regarding blocks 144 and 146 of FIG. 4, some computers and systems may not require such initialization processes, and may rather allow the user to proceed directly to block 148. Should it be determined that credential promotion is disabled or otherwise unavailable for the computer at block 144, the conventional enrollment sequence for the computer may be invoked at block 151.

FIG. 6 shows sequenced steps useful in determining from where to retrieve the first enrollment BIR, as discussed briefly in the text describing block 152 of FIG. 4. The flowchart of FIG. 6 shows exemplary programming options 282-288 that may be available to a network administrator or user configuring their promotion applications. While the embodiment shown in FIG. 6 affords a network administrator several programming options 282-288, another embodiment may offer only a single preset option, or may substitute another application determination process as per a system preference. Thus, while in accordance with the principles of the present invention, the application determination options 282-288 shown in FIG. 6 are included for exemplary purposes only.

Turning more particularly to FIG. 6, a network administrator may designate an application from which the first enrollment credential should be retrieved at block 282. At block 284, an administrator or user may alternatively configure the program code 42 to look toward the application 84 from which the user is attempting to access the second application 85 in order to find a suitable enrollment credential. Thus, the processes beginning at block 286 allow a user to designate the application 84 that they wish to have the enrollment credential retrieved from. Still another embodiment at block 288 may take direction from the application 85 into which the user wishes to enroll for locating a suitable enrollment credential.

Focusing first on those method steps stemming from block 282, the program code 42 may retrieve a stored address from a database or register accessible to the client computer 100 that is executing the program code 42. The retrieved address may correspond to a predetermined application 84 from which it is desirable to retrieve the enrollment credential. The designation of the application 84 may be made by the user or a network administrator, and may be substituted with another address as necessary. The program code 42 may then locate the application and/or enrollment credential at block 292. The program code 42 may verify that the enrollment credential is accessible at block 294. Should the program code 42 fail to locate or gain permission to the designated application at block 294, the program code 42 may look to a second address, if available at block 296.

At block 298, the program code 42 may evaluate the type of enrollment credential that is available in the second application to determine if it conforms with a system policy. Such a system policy may represent a rule set by a network administrator for an entire network regarding acceptable types of credentials. For instance, a network, and consequently, credential promotion processes executing within that network, may be configured to deny enrollment credentials that comprise voice recognition code. Similarly, the local user at block 300, in addition to the application that they wish to enroll in at block 302, may place constraints on what types of enrollment credentials are permitted. Thus, program code 42 may conduct evaluations in view of these local and application policies at blocks 300 and 302, respectively.

In the same or another embodiment, the program code 42 may select a most appropriate enrollment credential from those located at block 292 by accessing confidence ratings. Exemplary confidence ratings may be assigned by a user or network administrator to each type of credential and/or each application in a trust network. As such, the confidence rating of one embodiment may be indicative of the level of perceived security associated with its respective application or credential type. For instance, a higher confidence rating may be assigned to a fingerprint BIR than is assigned to a password of a user, by virtue of the BIR being more highly correlated to the user. Similarly, a network administrator may assign a higher confidence rating to an application that is under their own supervision and maintenance than to a second application having less familiar and uncertain security practices.

In one embodiment, the program code 42 may process the confidence ratings assigned to available credentials at block 307 to determine a mathematical preference. That is, the program code 42 may analyze the confidence ratings of each enrollment credential of a located application 84 to determine a preferred enrollment credential. Such analysis may include combining different confidence ratings assigned to different attributes of the same enrollment credential. For instance, an iris scan may have both a first confidence rating of “8.5” by virtue of its credential type and a second confidence rating of “7.0,” derived from the first application in which the user originally enrolled. The program code 42 of one embodiment may take some product or other weighted function of the two confidence ratings to arrive at single confidence rating. The code may alternatively focus on only the one assignment of the two deemed more significant from a security standpoint, for instance. Confidence ratings, for purposes of this specification, should be understood to include mere user/network preferences, and thus should not be limited to applications involving security considerations. Such ratings may have equal applicability with regard to processing considerations, personal tastes and conveniences, among other factors.

One skilled in the art should appreciate that numerous other tests and evaluations may be implemented to suit application requirements, and while any of these may be omitted, other suitable application selection processes may be added in accordance with the principles of the present invention. One such additional selection process is shown at block 306. The program code 42 at block 306 may determine from registers located on the user's current machine whether credential capture devices installed on the machine align with the type of credential data stored at the location designated at block 290.

Should the condition of block 306 fail, as with those associated with blocks 298-302, the user may be relegated to an alternative enrollment process at block 151, or a second address at block 296. Another embodiment may respond to a policy failure by transistioning to another enrollment credential determination option at blocks 284-288. Should the retrieved enrollment credential alternatively survive the battery of tests at blocks 298-306, then the program code 42 may retrieve the designated enrollment credential at block 156. As discussed herein, such retrieval processes may involve downloading of bitstream or other data descriptive of the enrollment credential to the local machine 100 of the user.

Another enrollment option represented at block 284 of FIG. 6 may access enrollment credential data corresponding to the application 84 from which the user is attempting to enroll into the second application 85. The program code 42 may look to registers of the local computer 100 to determine at block 308 what application 84 the user is utilizing. Having retrieved the applicable address from local memory at block 308, the program code 42 may locate the application 84 and, more particularly, where the enrollment BIR is stored at block 309.

The program code 42 may evaluate the stored enrollment credential in consideration of system policies as discussed above at block 310, as well as local policies at block 312. Where the located enrollment BIR conforms with the exemplary policies of blocks 310 and 312, the program code 42 may initiate retrieval of the enrollment BIR corresponding to the local application at block 156. Of note, the system, local, application and other policies discussed in the context of FIG. 6 may be accomplished alternatively at other points along the flowchart of FIG. 4. Another embodiment may omit them altogether, while still according with the principles of the present invention.

At block 286, another or the same embodiment may allow the user to designate from which application the enrollment credential should be retrieved. At block 314, the program code 42 may prompt the user to enter an address or other identifier correlated to an application 84 in which they are already biometrically enrolled. The prompt may originate from the program code 42 in connection with the application that the user desires to enroll in. In one embodiment, a drop-down list of applications into which the user is already enrolled may be displayed at the user terminal. To this end, the program code 42 at block 314 may order at the top of the list those applications into which the user has most recently enrolled. Such arrangement may encourage retrieval of the most up-to-date authentication credentials of the user. An administrator may set the number of applications displayed according to system policy and performance considerations.

FIG. 7 shows a suitable dialog box 74 having such a text field 77 and drop-down box 75. The user may scroll down the drop-down box to select the name of a desired application at block 316. If the name of the desired application is not displayed by the computer 100 at block 314 of FIG. 6, the embodiment may present the user with the option of typing the name of the application into a text field 77. As shown in FIG. 7, the user may submit the name of the application by depressing the “OK” button 83. The user may alternatively end a credential promotion session by selecting the “Cancel” button 87.

The program code 42 may then locate at block 317 of FIG. 6 the user-designed enrollment credential and/or application. Presuming the program code 42 succeeds in locating the user-designated address at block 317, system and local level evaluations may be accomplished at blocks 318 and 320. The program code 42 of the same embodiment may additionally determine if the user-designated enrollment credential accords with specifications transmitted from the application at block 322. Where the enrollment credential is determined to comply with all requirements, which may include a credential availability evaluation at block 306, the program code 42 may retrieve the user-designated enrollment credential at block 156.

In addition to designating the second application 85 and/or preferred enrollment credential, the user may also set a preference for future enrollment sessions at block 323. For instance, a user may stipulate a preference for using an enrollment BIR from a particular application. Should such a preference be designated at block 323, then that BIR or other preference will be recorded at block 325. As such, the program code 42 can recall the preference at block 316 of a subsequent promotion session. Alternatively, the user may not wish to set a preference at block 323, or an administrator may disable such an option, altogether.

Yet another application identification option at block 288 may be driven by the application 85 into which the user desires enrollment. This second, desired application 85 may instruct the program code 42 to look to a predetermined field or register at block 290. Such a field may be generic to all applications/computers anticipated to interact with the second application 85. A suitable address or field designated by the second application 85 may include one that corresponds to the enrollment credential of the application that the user is currently accessing. In any case, the program code 42 may retrieve the address and locate the identified enrollment credential/application at block 290. An embodiment may scrutinize the application-designated enrollment credential using local and system policies at blocks 294 and 296 prior to retrieving the approved enrollment credential at block 156. As with other embodiments of the invention, the sequence beginning at block 288 may additionally include an evaluation of BIR enrollment device availability at block 306.

Over time, changes to physical features of users can render previously stored enrollment data obsolete. Therefore, it may be desirable to periodically re-enroll a user into every application for which they have access. The present invention may accommodate such updates as may be made to existing enrollment authentication data. For instance, where a user updates an enrollment credential for a first application 84, that updated enrollment credential may be automatically transferred to the second application 85 for use as its own enrollment credential. In this manner, a single update may be used to simultaneously update two or more applications using promotion processes.

FIG. 8 shows one such scenario consistent with the principles of the present invention. At block 166 of FIG. 8, the enrollment credential of the first application 84 has been stored as the enrollment credential for the second application 85, as discussed in the text describing FIGS. 1-3. At a subsequent time, the user may initiate an event 402-406 that may affect the enrollment credential of the first application 84. For instance, the user may re-register, or update, their enrollment BIR at block 402. As such, the program code 42 may store the newly registered enrollment BIR in place of the earlier enrollment BIR at block 408.

Alternatively, the user may enroll a new enrollment credential type in addition to the existing enrollment BIR. For instance, a user having a fingerprint enrollment BIR may additionally store a BIR directed to a cranial measurement. As such, the program code 42 may store the additional enrollment credential at block 408. The user may alternatively substitute a new type of enrollment credential for their existing enrollment BIR at block 406. After accomplishing the new type of enrollment credential, the old type of enrollment BIR may be deleted at block 408 with the new enrollment credential being stored in its place.

The same user at block 410 may subsequently seek and be granted access to the second application at blocks 410-414. Where desired, the second application may verify the identity of the user at block 412 by utilizing the enrollment BIR originally stored at block 400. At block 416, an embodiment may call for the program code 42 to determine if a change to the enrollment BIR of the first application has occurred. That is, the program code 42 may monitor registers associated with the application from which the enrollment BIR originated to detect a change in the enrollment file status.

If such a change is detected at block 416, the program code 42 may prompt the user at 418 as to whether they desire to update the enrollment credential of the second application 85 in accordance with first. A subsequent response received from the user may cause the program code 42 to download the newly-registered credential from the first application 84 at block 420. Where a user alternatively communicates an unwillingness to update the enrollment credential of the second application 85, the original enrollment credential may be retained at block 417. Where desired, the program code 42 may ask the user to confirm their desire with a submission of a capture credential. The capture credential may be matched against the existing enrollment credential. Alternatively or in addition, the program code 42 may allow a user or network administrator to disable the verification processes of blocks 418 and 420, and may proceed directly with downloading the new credential at block 422. Still another scenario consistent with the principles of the present invention may automatically update the enrollment credential of a second application in response to the user updating their credential in the first application.

In any case, the newly stored credential of the first application 84 may be downloaded to the local computer 100 of the user. However, in one embodiment, the downloaded credential from the first application 84 may not yet be stored as the enrollment credential for the second application 85. The program code 42 of such an embodiment may first prompt the user to authenticate against the downloaded authentication credential. Such precaution may guard against security risks, while ensuring that the user will continue to have access to the second application 85. Thus, the program code 42 may prompt the user to submit a new capture credential at block 424. In one embodiment, the new capture credential will be the same type of enrollment credential as that of the enrollment credential retrieved from the first application.

The program code 42 of another or the same embodiment may include tests at block 423 designed to determine the appropriateness of the downloaded enrollment credential. Such tests may include system and local policy instructions, as well as verification that a suitable credential capture device is present on the local machine 100 of the user. A determined match of the capture credential submitted at block 424 and the enrollment credential from the first application downloaded at block 422 may cause the program code 42 to store the new enrollment credential as the enrollment credential for the second application at block 400. Among other benefits, this practice ensures the most up-to-date enrollment information is used in conjunction with secured access.

In use, features of the present invention allow a user who is authenticated in one application to enroll in a different application without having to accomplish conventional enrollment processes. That is, an authenticated user who is already enrolled into a first computer application 84 may automatically transfer the enrollment credential of the first computer application 84 to a second application 85. As such, the user may enroll in the second application 85 without having to repetitively resubmit capture credentials to create an enrollment credential for a single application Thus, enrollment credentials may be automatically established and updated across multiple computer applications in a manner that achieves automatic enrollment of the user credential.

The retrieved, or “promoted” enrollment credential from the first application 84 then becomes available for matching against a capture credential that is correlated to the user. While a capture credential submitted by a user will suffice, the capture credential used to establish an enrollment credential may alternatively be retrieved from memory. Where so configured, a recently stored capture BIR may be downloaded directly for comparison against an enrollment BIR. Thus, aspects of the invention may obviate the need for the user to submit a capture credential in order to be enrolled.

In any case, where a match between the capture and enrollment credential is determined, the enrollment credential of the first application 84 is stored as the enrollment credential for the second application 85. Where so desired, a user may simultaneously be enrolled in multiple, different applications in similar fashion. In this manner, a single authentication credential may be simultaneously promoted to several applications, thus enrolling the user instantly in a multitude of applications. Such a feature of the present invention may mitigate lengthy time demands associated with conventional enrollment practices. As discussed above, similar features of the invention may apply equally to the updating of credentials throughout a network. One or more enrollment credentials correlated to a user may be automatically updated in response to the user updating an enrollment credential in another application. Thus, embodiments of the present invention can enable further time savings and efficiencies.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. For example, authentication credential and user identification information may be encrypted at any step delineated in the above discussed flowcharts in accordance with the principles of the present invention.

Moreover, the sequence of the steps in the included flowcharts may be altered, to include omitting certain processes without conflicting with the principles of the present invention. Similarly, related or known processes can be incorporated to complement those discussed herein. One such feature consistent with the invention may include the program code 42 locating a suitable enrollment credential after scanning all or part of a trust network for credentials/applications stored in associative relationship with an ID or other identifier of the user.

It should furthermore be understood that any of the embodiments and associated programs discussed above are compatible with all known enrollment processes and may further be optimized to realize even greater efficiencies. For instance, a program that locally stores BIR data in response to a successful login/enrollment may be complimented by features of the present invention. Such a program may cause an accessing user to provide capture BIR data to a local computer when accessing a network server. In one scenario, the present invention may accommodate retrieval and local storage of the enrollment BIR of a first application from the server at the client computer following a credential promotion sequence. Such enrollment data may have application for facilitating enrollment for remote clients, such as disconnected laptop users. The general process of locally storing biometric data in response to a successful login is disclosed in International Application No. PCT/US01/30458, which was filed on Sep. 28, 2001, is entitled “Biometric Record Caching,” and is hereby incorporated by reference in its entirety.

Moreover, while one embodiment described herein concerns a networked operation, one skilled in the art will appreciate the principles of the present invention apply equally to stand-alone computers as well. The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A method of automatically enrolling a user who is already enrolled into a first computer application into a second computer application for which the user is not yet enrolled, comprising:
retrieving an enrollment credential correlated to the user's enrollment in the first computer application;
retrieving a capture credential correlated to the user;
determining if the capture credential matches the retrieved enrollment credential within predetermined parameters; and
if there is a match of the capture credential and the retrieved enrollment credential, storing the retrieved enrollment credential as correlated to the user's enrollment in the second computer application, whereby to enroll the user into the second application.

2. The method of claim 1, wherein if there is a match of the capture credential and the retrieved enrollment credential, further comprising allowing the user access to at least a portion of the second application.

3. The method of claim 1, wherein if there is no match of the capture credential and the retrieved enrollment credential, further comprising not storing the retrieved enrollment credential.

4. The method of claim 1, wherein if there is no match of the capture credential and the retrieved enrollment credential, further comprising not allowing the user access to the second application.

5. The method of claim 1, wherein if there is no match of the capture credential and the retrieved enrollment credential, further comprising initiating a different enrollment procedure.

6. The method of claim 1, wherein retrieving the enrollment credential correlated to the user's enrollment credential in the first computer application further comprises determining an identifier correlated to the user for the first computer application.

7. The method of claim 1, wherein retrieving the enrollment credential correlated to the user's enrollment credential in the first computer application further comprises retrieving the user's enrollment credential from a login application used by the user to access the local machine from which the user initiated enrollment procedures for the second computer application.

8. The method of claim 1, wherein retrieving the enrollment credential correlated to the user's enrollment credential in the first computer application further comprises locating the first computer application from an application address input by the user.

9. The method of claim 1, wherein retrieving the enrollment credential correlated to the user's enrollment credential in the first computer application further comprises retrieving the user's enrollment credential from a primary application designated for the user.

10. The method of claim 1, wherein retrieving the enrollment credential correlated to the user's enrollment credential in the first computer application further comprises retrieving a set of credentials.

11. The method of claim 10, further comprising determining an appropriate credential from among the set of credentials in response to user input.

12. The method of claim 10, further comprising automatically determining the appropriate credential from among the set of credentials.

13. The method of claim 12, wherein determining the appropriate credential further comprises accessing at least one policy selected from a group consisting of: a system policy, a local policy, a user policy, a confidence rating and authenticating device availability.

14. The method of claim 1, wherein storing the retrieved enrollment credential further comprises storing the retrieved enrollment credential on at least one platform selected from a group consisting of: a local computer, a networked computer, a server, a token and a portable electronic device.

15. The method of claim 1, wherein storing the retrieved enrollment credential further comprises first verifying that the user desires to store the retrieved enrollment credential in the second application.

16. The method of claim 1, wherein storing the retrieved enrollment credential further comprises first determining if a second capture credential received from the user matches the retrieved enrollment credential within the predetermined parameters.

17. The method of claim 1, wherein the credential further comprises at least one authentication mechanism selected from a group consisting of: a BIR, a token and a password.

18. The method of claim 1, wherein retrieving the capture credential further comprises retrieving the capture credential from memory.

19. The method of claim 1, wherein retrieving the capture credential further comprises receiving the capture credential from the user.

20. The method of claim 1, wherein retrieving the capture credential further comprises retrieving the capture credential from an electronic transmission.

21. The method of claim 1, wherein storing the retrieved enrollment credential further includes storing an updated credential from the first computer application.

22. The method of claim 21, wherein storing the updated credential further comprises storing the updated credential in response to user input.

23. The method of claim 21, wherein storing the updated credential further comprises automatically storing the updated credential in response to the updated credential being accomplished in the first computer application.

24. The method of claim 1, further comprising storing an accounting of the automatic enrollment within memory.

25. The method of claim 1, wherein storing the retrieved enrollment credential as correlated to the user's enrollment credential in the second computer application further comprises simultaneously storing the retrieved enrollment credential as correlated to the user's enrollment in a third application, whereby to enroll the user into the third application.

26. The method of claim 25, wherein the retrieved enrollment credential further comprises an update.

27. The method of claim 1, wherein retrieving the enrollment credential correlated to the user's enrollment in the first computer application further comprises determining a trust network.

28. A method of automatically enrolling a user who is already biometrically enrolled in a first computer application into a second computer application for which the user is not yet biometrically enrolled, comprising:
retrieving an enrollment BIR correlated to the user's enrollment in the first computer application;
receiving a capture BIR submitted by the user;
determining if the capture BIR matches the retrieved enrollment BIR within predetermined parameters; and
if there is a match of the capture BIR and the retrieved enrollment BIR, storing the retrieved enrollment BIR as correlated to the user's enrollment in the second computer application, whereby to enroll the user into the second application.

29. A method of automatically updating an enrollment credential of a first application in response to the user's establishing an enrollment credential for a second application, comprising:
storing a retrieved enrollment credential as correlated to the user's enrollment in the second application;
determining if the retrieved enrollment credential is appropriate for use in the user's enrollment into the first application;
if the retrieved enrollment credential is determined to be appropriate, storing the retrieved enrollment credential as correlated to the user's enrollment into the first application, whereby to update the enrollment credential of the first application.

30. The method of claim 29, further comprising retrieving the retrieved enrollment credential from memory.

31. The method of claim 29, further comprising retrieving the retrieved enrollment credential from a capture authentication credential.

32. The method of claim 29, wherein determining if the enrollment credential is appropriate further comprises verifying the user's desire to store the retrieved enrollment credential as correlated to the user's enrollment into the first application.

33. The method of claim 32, wherein the verifying further comprises receiving a capture authentication credential submitted by the user.

34. The method of claim 29, wherein storing the retrieved enrollment further comprises storing the retrieved enrollment credential as an additional enrollment credential correlated to the user's enrollment into the first application.

35. An apparatus, comprising:
a controller having access to first and second computer applications; and
program code configured to execute on the controller and to retrieve an enrollment credential correlated to a user's enrollment in the first computer application; the program code further configured to retrieve a capture credential correlated to the user and to determine if the capture credential matches the retrieved enrollment credential within predetermined parameters, and if there is a match of the capture credential and the retrieved enrollment credential, the program code is further configured to store the retrieved enrollment credential as correlated to the user's enrollment in the second computer application, whereby to enroll the user into the second application.

36. The apparatus of claim 35, wherein if there is a match of the capture credential and the retrieved enrollment credential, the program code allows the user access to at least a portion of the second application.

37. The apparatus of claim 35, wherein if there is no match of the capture credential and the retrieved enrollment credential, the program code does not store the retrieved enrollment credential.

38. The apparatus of claim 35, wherein if there is no match of the capture credential and the retrieved enrollment credential, the program code denies the user access to the second application.

39. The apparatus of claim 35, wherein if there is no match of the capture credential and the retrieved enrollment credential, the program code initiates a different enrollment procedure.

40. The apparatus of claim 35, wherein the program code initiates retrieval of the user's enrollment credential from a login application used by the user to access the local machine from which the user initiated enrollment procedures for the second computer application.

41. The apparatus of claim 35, wherein the program code initiates locating the first computer application from an application address input by the user.

42. The apparatus of claim 35, wherein the program code initiates retrieving the user's enrollment credential from a primary application designated for the user.

43. The apparatus of claim 35, wherein the program code initiates retrieving an appropriate credential from among the set of credentials in response to user input.

44. The apparatus of claim 43, wherein the program code initiates determining the appropriate credential further comprises accessing at least one policy selected from a group consisting of: a system policy, a local policy, a user policy, a confidence rating and authenticating device availability.

45. The apparatus of claim 35, wherein the program code initiates storing the retrieved enrollment credential on at least one platform selected from a group consisting of: a local computer, a networked computer, a server, a token and a portable electronic device.

46. The apparatus of claim 35, wherein the program code first verifies that the user desires to store the retrieved enrollment credential in the second application.

47. The apparatus of claim 35, wherein the program code initiates determining if a second capture credential received from the user matches the retrieved enrollment credential within the predetermined parameters prior to storing the retrieved enrollment credential.

48. The apparatus of claim 35, wherein the credential further comprises at least one authentication mechanism selected from a group consisting of: a BIR, a token and a password.

49. The apparatus of claim 35, wherein the program code initiates retrieving the capture credential from a group consisting of: an electronic transmission, a memory, a user submission and a combination thereof.

50. The apparatus of claim 35, wherein the retrieved enrollment credential is stored as an update.

51. The apparatus of claim 35, wherein the program code initiates storing an accounting of the automatic enrollment within memory.

52. The apparatus of claim 35, wherein the program code initiates simultaneously storing the retrieved enrollment credential as correlated to the user's enrollment in a third application, whereby to enroll the user into the third application.

53. The apparatus of claim 52, wherein the retrieved enrollment credential is an update.

54. The apparatus of claim 35, wherein the program code initiates determining a trust network.

55. An apparatus, comprising:
a controller having access to first and second computer applications; and
program code configured to execute on the controller and to retrieve an enrollment BIR correlated to a user's enrollment in the first computer application; the program code further configured to receive a capture BIR correlated to the user and to determine if the capture BIR matches the retrieved enrollment BIR within predetermined parameters, and if there is a match of the capture BIR and the retrieved enrollment BIR, the program code is further configured to store the retrieved enrollment BIR as correlated to the user's enrollment in the second computer application, whereby to enroll the user into the second application.

56. An apparatus, comprising:
a controller having access to first and second computer applications; and
program code configured to execute on the controller and to store a retrieved enrollment credential as correlated to a user's enrollment in a first application; the program code further configured to determine if the retrieved enrollment credential is appropriate for use in the user's enrollment into a second application, wherein the user is already enrolled in the second application, and if the retrieved enrollment credential is determined to be appropriate, the program code being further configured to store the retrieved enrollment credential as correlated to the user's enrollment into the second application, whereby to update the enrollment credential of the second application.

57. The apparatus of claim 56, wherein the program code initiates retrieval of the retrieved enrollment credential from memory.

58. The apparatus of claim 56, wherein the program code initiates retrieval of the retrieved enrollment credential from a capture authentication credential submitted by the user.

59. The apparatus of claim 56, wherein the program code initiates verifying the user's desire to store the retrieved enrollment credential as correlated to the user's enrollment into the first application.

60. The apparatus of claim 59, wherein the program code initiates reception of a capture authentication credential.

61. The apparatus of claim 56, wherein the program code initiates storing the retrieved enrollment credential as an additional enrollment credential correlated to the user's enrollment into the first application.

62. A program product, comprising:
a program configured to execute on a controller having access to first and second computer applications, and to retrieve an enrollment credential correlated to a user's enrollment in the first computer application; the program code further configured to retrieve a capture credential correlated to the user and to determine if the capture credential matches the retrieved enrollment credential within predetermined parameters, and if there is a match of the capture credential and the retrieved enrollment credential, the program code is configured to store the retrieved enrollment credential as correlated to the user's enrollment in the second computer application, whereby to enroll the user into the second application; and
a signal bearing medium bearing the first program.

63. The program product of claim 62, wherein the signal bearing medium includes at least one of a recordable medium and a transmission-type medium.

64. A program product, comprising:
a program configured to execute on the controller and to store a retrieved enrollment credential as correlated to a user's enrollment in a first application; the program code further configured to determine if the retrieved enrollment credential is appropriate for use in the user's enrollment into a second application, wherein the user is already enrolled in the second application, and if the retrieved enrollment credential is determined to be appropriate, the program code being further configured to store the retrieved enrollment credential as correlated to the user's enrollment into the second application, whereby to update the enrollment credential of the second application; and
a signal bearing medium bearing the first program.

65. The program product of claim 64, wherein the signal bearing medium includes at least one of a recordable medium and a transmission-type medium.
